(19) United States
(12) Patent Application Publication
(10) Pub. No.: US 2009/0236418 A1
(43) Pub. Date: Sep. 24, 2009

(54) USB Card Reader with Auto-Execution and Method Thereof

(76) Inventors: Chang Liang Hsi, Hsin-Chu City (TW); Chen Che-Yu, Hsin-Chu City (TW); Shen Li Yen, Hsin-Chu City (TW)

Correspondence Address: TROXELL LAW OFFICE PLLC, 5205 LEESBURG PIKE, SUITE 1404, FALLS CHURCH, VA, 22041, US

(21) Appl. No.: 12/360,192

(22) Filed: Jan. 27, 2009

(30) Foreign Application Priority Data
Jan. 28, 2008 (TW) 097103080

(51) Int. Cl. G06K 5/00

(52) U.S. Cl. 235/382

(57) ABSTRACT

A USB card reader with auto-execution and method thereof is disclosed. A HID and an auto-key-in device are included in the USB card reader to execute an on-access program automatically when the USB card reader is mounted with a host system. One or a plurality of characters are keyed in the host system by the auto-key-in device through the HID and they may comprises a hot key for on-access program execution, a website address, a password or a finger print identification data.

### BACKGROUND OF THE INVENTION

1. Field of the Invention

This invention relates to a Universal Serial Bus (USB) card reader and, more particularly, to a USB card reader with auto-execution and method thereof, wherein the auto-execution is to execute one or a plurality of on-access programs in a host system or to connect one or a plurality of web-sites after validly connecting to the host system.

2. Description of the Prior Art

A main structure for USB card reader available on the market is shown in FIG. 4. A USB client controller A is coupled with the host system B and a buffer management unit D which is coupled with a connection interface G A micro processing unit C is coupled with the host system B, the USB client controller A, a Random Access Memory (RAM) E, a Read Only Memory F, the buffer management unit D and the connection interface G for controlling data access on the memory card H. Data access on a memory card H from a host system B can be arranged by a convectional USB card reader. For the needs of data reading, copies or movement, a buffer I coupled with the buffer management unit D can be arranged during as event of read access or write access.

The said structure for USB card reader is flexible for different size of memory cards. Thus, the USB card reader with said structure becomes very popular on the market. However, it is just for card reading only. Memory card can not be used as a key to turn an on-access host program or link a specified web-site through the said USB card reader.

### SUMMARY OF THE INVENTION

The present invention discloses a USB card reader with auto-execution and method thereof. A Human Interface Device (HID) and an auto-key-in device are built in the USB card reader with auto-execution. When the USB card reader with auto-execution is connected to a host system, a micro processing unit identifies the HID and reads default character information. An on-access program in the host system or a linking to specified web-site can be executed for characters automatically keyed by the auto-key-in device.

In order to achieve the objectives, a USB card reader with auto-execution in the present invention comprises: a USB client controller, a micro processing unit, a buffer management unit, a HID, and an auto-key-in device. The micro processing unit is coupled with the USB client controller, a RAM, a ROM and a connection interface. The connection interface is coupled with one or a plurality of memory cards for arrangement of data reading, copy or movement. The buffer management unit is coupled with the USB client controller, the connection interface and the micro processing unit for management data access on a buffer. The HID is coupled with the micro processing unit and the auto-key-in device is coupled with the HID for keying in one or a plurality of characters to execute an on-access program in the host system.

In some embodiments of the USB card reader, the characters keyed by auto-key-in device are built in the ROM, Erasable Programmable Read Only Memory (EPROM) or the memory card. The characters keyed by auto-key-in device can be loaded from an infrared transmitter.

A method for USB card reader with auto-execution comprises the following steps: (a) providing a card reader which can automatically send a request to a host system for HID connection; and (b) providing an auto-key-in device in order to key in one or a plurality of characters for auto-run of an on-access program.

In one embodiment of the present invention, the auto-key-in device is detected by the micro processing unit or the USB client controller. Then, one or a plurality of characters read by the micro processing unit can be keyed in through the auto-key-in device.

For a more complete understanding of the features and advantages of the present invention, reference is now made to the following description taken in conjunction with accompanying drawings, in which:

### BRIEF DESCRIPTION OF THE DRAWINGS

FIG. 1 shows block diagram of the first embodiment for USB card reader in the present invention.

FIG. 2 shows block diagram of the second embodiment for USB card reader in the present invention.

FIG. 3 shows flow chart for using the USB card reader in the present invention to auto-execute an on-access program.

FIG. 4 shows block diagram for conventional USB card reader.

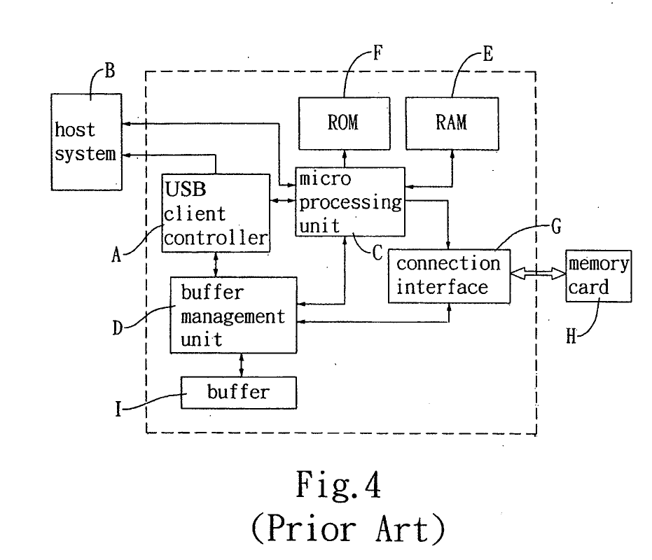

### DETAILED DESCRIPTION OF THE PREFERRED EMBODIMENTS

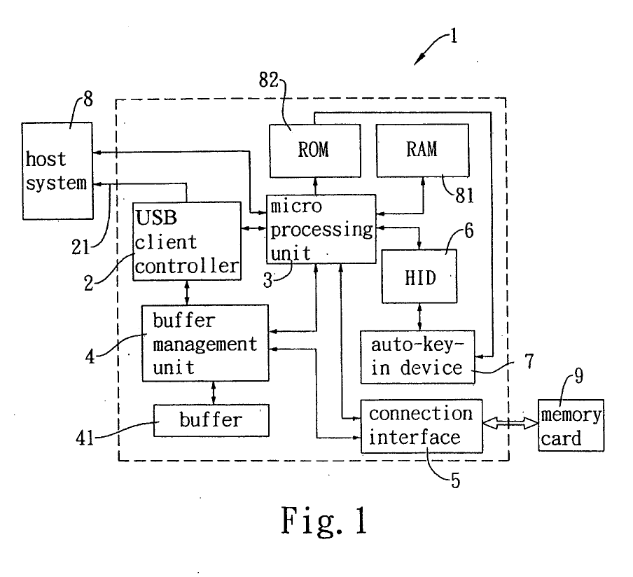

The first embodiment for USB card reader 1 in the present invention is shown in FIG. 1. The card reader comprises: a USB client controller 2, a micro processing unit 3, a buffer management unit 4, a connection interface 5, a Human Interface Device (HID) 6 and an auto-key-in device 7.

The USB client controller 2 is coupled with a host system 8 to receive signals from the host system through a USB connector 21.

The micro processing unit 3 is coupled with the host system 8, the USB client controller 2, the buffer management unit 4, the connection interface 5, the HID 6, a RAM 81 and a ROM 82. The buffer management unit 4 is coupled with the USB client controller 2, micro processing unit 3 and the connection interface 5 for management of data access on a buffer 41. The connection interface 5 is coupled with a memory card 9 for arrangement of data reading, copy or movement. The HID 6 is coupled with the auto-key-in device 7 which is an electrical circuit. The characters input through the HID 6 are built in the ROM 82.

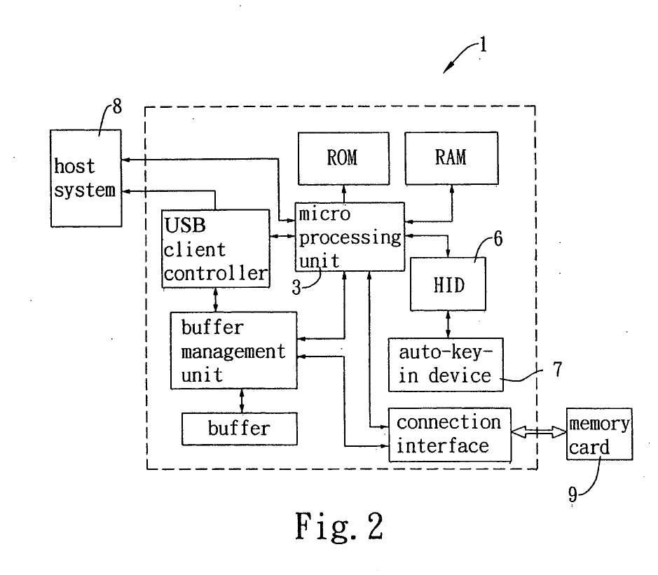

The characters input through the HID 6 can be stored in an Erasable Programmable Read Only Memory (EPROM) which is built in the circuit board of USB card reader 1. Then, the stored characters can be erased and wrote repeatedly. The stored characters can be stored in a block of the memory card 9 as shown in FIG. 2. When the memory card 9 is inserted into the USB card reader 1, the stored character can be read by the micro processing unit 3 and loaded to the auto-key-in device 7. Then, the stored characters are keyed in the host system 8 through the HID 6 for auto-execution of on-access program in the host system 8. An infrared receiver (not shown) arranged in the USB card reader 1 can load characters for auto-key-in device 7 from an infrared transmitter.

The character keyed by the auto-key-in device 7 is a hot key in order to execute on-access programs in the host system 8 directly (such as web browser execution program). A website address can be included by the keyed characters in order to access the specified website right after the short of web browser. An identified password or an identification file of finger print data can be included by the keyed characters for identification procedure in the host system 8.

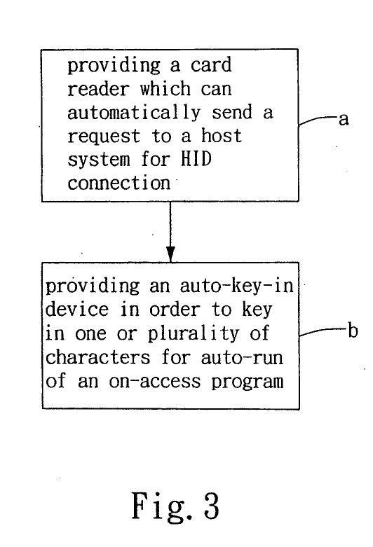

As shown in FIG. 3, method under structure of the USB card reader 1 with auto-execution comprises the following steps:

(a) providing a card reader which can automatically send a request to a host system for HID connection; and

(b) providing an auto-key-in device in order to key in one or a plurality of characters for auto-run of an on-access program.

The HID 6 is a common device class in computer system (such as keyboard, mice and joystick). When a connection between the USB card reader 1 and the host computer 8 is valid, the USB card reader sends a request for HID connection. In one embodiment, the HID 6 is described as a keyboard input. The validation of the auto-key-in device 7 can be checked either by the micro processing unit 3 or the USB client controller 2 for processing auto-execution. When the auto-key-in device is valid, the micro processing unit 3 can load one or a plurality of characters from the ROM 82, EPROM or the memory card 9 to the auto-key-in device 7. Then, the auto-key-in device 7 can send the characters to the host system 8 in order to process an on-access program, to link specified website or to provide a data set for processing program.

Accordingly, the USB card reader 1 disclosed in the present invention has the following advantages:
a. For the auto-linkage to a specified website, the card reader can be treated as a promotion gift or a storage device of website address to link user favorite websites easily and quickly; and
b. For the auto-key-in characters, the card reader can be used as an identification key to provide an identification password or a finger print file for identification program.
And, the USB card reader disclosed in the present invention can achieve the said objectives. Using the USB card reader, an on-access program in the host system and a specified website can be processed or linked automatically. It really improves its industrial application.

It should be understood that different modifications and variations could be made from the disclosures of the present invention by the people familiar in the art, which should be deemed without departing the spirit of the present invention.

What is claimed is:

1. A Universal Serial Bus (USB) card reader comprises:
(a) a USB client controller;
(b) a micro processing unit which is coupled with the U SB client controller; a Random Access Memory (RAM), a Read Only Memory (ROM) and a connection interface coupling with a memory card in order to control data access between the memory card and a host system;
(c) a buffer management unit which is coupled with the USB client controller, the connection interface and the micro processing unit for data access on a buffer;
(d) a Human Interface Device (HID) which is coupled with the micro processing unit; and
(e) an auto-key-in device which is coupled with the HID in order to key in one or a plurality of characters through the HID and execute an on-access program in the host system.

2. A USB card reader according to claim 1, wherein characters keyed by the auto-key-in device through the HID is loaded from built-in characters of the ROM.

3. A USB card reader according to claim 1, wherein characters keyed by the auto-key-in device through the HID is loaded from an Erasable Programmable Read Only Memory (EPROM) which is built in the USB card reader.

4. A USB card reader according to claim 1, wherein characters keyed by the auto-key-in device is loaded from characters stored in the memory card.

5. A USB card reader according to claim 1, wherein characters keyed by the auto-key-in device is a hot key.

6. A USB card reader according to claim 1 further comprises an infrared receiver to receive characters transmitted from an infrared transmitter for the auto-key-in device.

7. A method using a Universal Serial Bus (USB) card reader to execute an on-access program in a host system comprises the following steps:
(a) providing a card reader to send a request to the host system for a Human Interface Device (HID) connection; and
(b) providing an auto-key-in device to key in one or a plurality of characters through the HID for on-access program execution in the host system.

8. A method according to claim 7 further comprises one step: providing a micro processing unit to check validation of the auto-key-in device.

9. A method according to claim 7 further comprises one step: providing a USB client controller to check validation of the auto-key-in device.

10. A method according to claim 8 further comprises one step: providing a micro processing unit to load one or a plurality of characters for the auto-key-in device.

11. A method according to claim 9 further comprises one step: providing a micro processing unit to load one or a plurality of characters for the auto-key-in device.

12. A method according to claim 7, wherein characters keyed by the auto-key-in device comprises a website address.

13. A method according to claim 7, wherein characters keyed by the auto-key-in device comprises an identification password.

14. A method according to claim 7, wherein characters keyed by the auto-key-in device comprises a finger print identification data.
